(19) United States
(12) Patent Application Publication
(10) Pub. No.: US 2026/0316810 A1
(43) Pub. Date: Oct. 15, 2026

(54) SHOPPING TROLLEY WITH SMART SYSTEM

(71) Applicant: ST YAZILIM PROGRAMCILIK GIDA SANAYI TICARET LIMITED SIRKETI, BEYLIKDÜZÜ, ISTANBUL (TR)

(72) Inventors: Sergun ÖZMEN, BEYLIKDÜZÜ, ISTANBUL (TR); Tolga SANDAL, BEYLIKDÜZÜ, ISTANBUL (TR)

(21) Appl. No.: 18/877,024

(22) PCT Filed: Dec. 21, 2023
(86) PCT No.: PCT/TR2023/051637

§ 371 Date: Dec. 19, 2024

(51) Int. Cl. B62B 3/14; B62B 5/00; B62B 5/04; G06Q 30/06

(52) U.S. Cl. CPC B62B 3/1424; B62B 5/0096; B62B 5/0414; G06Q 30/06; B62B 2203/50

(57) ABSTRACT

Disclosed is a shopping trolley with smart system having a code located on the shopping trolley and defined specifically for each shopping trolley in the data centre to enable the shopping trolley to be activated after being read by the application installed on the customer's mobile device. A sensor detects products being placed in or removed from the shopping basket. A weight detection unit detects the weight change when products are placed in or removed from the basket. A camera receives and transmits images of the product in order to identify the product placed in the basket. A control unit receives images from the camera, performs product recognition and matching processes in the data centre, and displays the information about the products to the customer via the screen on it.

### TECHNICAL FIELD

The invention relates to a shopping trolley with a smart system that enables the contents of the products purchased in supermarkets to be examined during shopping and the payment of the purchased products to be carried out independently without waiting in line.

### PRIOR ART

Nowadays, most people prefer supermarkets to meet their basic and other needs. Shopping trolleys are also often found in supermarkets and make it easier for shoppers to shop. When customers enter the supermarket, they can take the trolley from the trolley section directly or by using coins. They drive the shopping trolleys and load the products in the desired aisle to the shopping trolley. To pay for the products in the shopping trolley, you need to go to the cash desk. The customer whose turn comes at the cash register takes the products from the shopping trolley and places them on the cash register belt. The cashier runs the products through the barcode reader one by one, calculates the cost and informs the customer of the amount to be paid. The customer can pay the fee in cash or by using a POS device.

Customers have to come to the cash desk to access product details and make payment. Due to the increase in the number and variety of products in supermarkets, customers may obtain inadequate or incorrect information about the details of the products (price, content, etc.) while buying products from the aisle. In this case, customers buy the wrong products or products that they cannot buy for different reasons (such as lack of budget, product with unwanted content) or realise this situation when it is their turn at the checkout. On the other hand, as the number of customers increases, long queues may form at the cash desk, which may cause unnecessary time loss. As a result of these, customer dissatisfaction arises. Shopping baskets, which are in common practice, can only help customers in carrying the products and taking them to the cashier, but cannot solve the problems mentioned.

As a result of the research made in the prior art, document No TR2022/005583 is encountered. The application relates to a shopping trolley which enables the price information of the products in the supermarket to be learnt. The shopping trolley in question shows the price information of the products to the user by means of a barcode reader. However, the application does not allow the contents of the products to be examined during the shopping process and the payment of the purchased products cannot be realised.

As a result due to the abovementioned disadvantages and the insufficiency of the current solutions regarding the subject matter, a development is required to be made in the relevant technical field.

### Aim of the Invention

The invention aims to solve the abovementioned disadvantages by being inspired from the current conditions.

The main aim of the invention is to enable the contents of the products purchased in supermarkets to be examined during shopping and the payment of the purchased products to be carried out independently without waiting in line.

To fulfil the above-mentioned purpose, shopping trolley with smart system has been developed, comprising the following;
code located on the shopping trolley and defined specifically for each shopping trolley in the data centre, which enables the shopping trolley to be activated after being read by the application installed on the customer's mobile device,
sensor that detects products being placed in or removed from the shopping basket,
weight sensing unit that detects the weight change when products are placed in or removed from the basket,
camera that receives and transmits images of the product in order to identify the product left in the basket,
control unit that receives images from the camera, performs product recognition and matching processes in the data centre, and displays the information about the products to the customer via the screen thereon.

Other preferred embodiments of the invention comprise the following elements, which may be included in each of the same or different embodiments:
reader that reads the barcode of the product to identify the product,
brake mechanism that stops the car wheels,
sensing arm which is activated when held by the customer and deactivates the brake mechanism,
lighting unit emitting light in different colours to inform the customer by receiving data on the product recognition process by the control unit,
control unit that ensures that the payment of the products received is made,
payment unit where contactless payment is made.

The structural and characteristic features of the present invention will be understood clearly by the following drawings and the detailed description made with reference to these drawings and therefore the evaluation shall be made by taking these figures and the detailed description into consideration.

### FIGURES TO HELP UNDERSTANDING OF THE INVENTION

FIG. 1 is a representative view of the shopping trolley with smart system which is subject of the invention.

FIG. 2a is an alternative embodiment of the body of the shopping trolley with smart system which is subject of the invention.

FIG. 2b is a two-dimensional view of FIG. 2a from the top.

FIG. 2c is a two-dimensional view of FIG. 2a from the front.

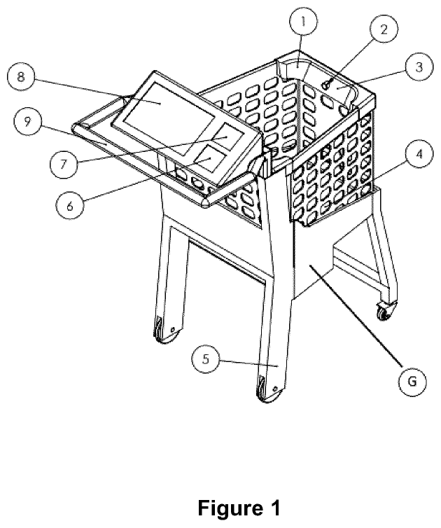

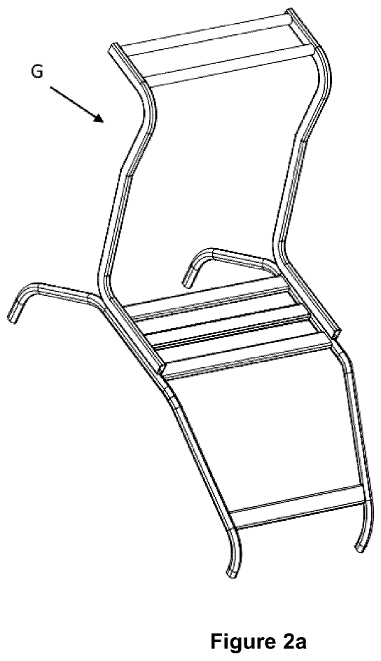

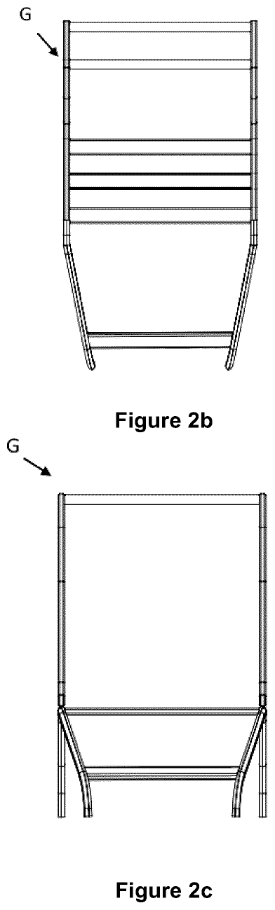

### Description of the Part References

1. Lighting unit
2. Camera
3. Sensor
4. Weight sensing unit
5. Brake mechanism
6. Reader
7. Payment unit
8. Control unit
9. Sensing arm
G: Body

### Detailed Description of the Invention

In this detailed description, the preferred embodiments of the inventive shopping trolley with smart system (supermarket trolley) are described by means of examples only for clarifying the subject matter.

The invention comprises a shopping trolley body (G) and a control unit (8). At the bottom of the storage basket of the shopping trolley, there is a weight sensing unit (4) that weighs the products, a camera (2) to detect the products around the basket, a lighting unit (1), sensors (3) and a reader (6) that reads barcodes, a sensing arm (9) to detect that the market trolley is used, and a brake mechanism (5) that stops the trolley wheels.

The control unit (8) has a display for informing customers and contains embedded system software that can connect and manage all units on the trolley. Furthermore, in the invention, a mobile application performs customer-shopping trolley matching to activate the shopping trolleys.

Each shopping trolley has its own code defined in the data centre on the system. This code is located on the shopping trolley. When the customer enters the market, he/she activates the shopping trolley by scanning the code with the mobile application. The shopping trolley can only move when the sensing arms (9) are held. Otherwise, the brake mechanism (5) is activated. The products that the customer puts in or takes out of the basket are detected using sensor (3), lighting unit (1) and camera (2). The weight change that will occur when the product is placed in or removed from the basket is detected by the weight sensing unit (4). Thus, the verification of the product determined by camera (2) is carried out together with the weight of the product. In case of unrecognisable products, product recognition can also be performed with the help of a barcode reader (6). The products purchased by the customer and the list of information about the products and the total amount to be paid are instantly displayed to the customer after each product detection by means of the software on the control unit (8). In addition, customers can follow which aisle the products are in and other information about the supermarket (such as discounted products, alternative products and campaigns) on the screen on the control unit (8). Thus, the customer is informed about the products and their amounts without going to the cash desk. When the customer completes his/her shopping, the total basket amount is automatically withdrawn from the credit cards previously defined in the system with the help of the user screen and mobile application.

By means of camera (2), images of the product are taken and recorded in order to identify the product placed in the basket of the shopping trolley. The lighting unit (1) provides the appropriate lighting for the image processing used by the camera (2) to detect the product left on the trolley.

The sensors (3) in the shopping basket are activated when the product is placed in the shopping basket and when it is taken back. The weight detection unit (4) allows the product placed in the shopping basket to be controlled by measuring its weight after it is detected by the camera (2) as a result of image processing.

The sensing arm (9) on the trolley is activated when the customer holds the shopping basket and the brake mechanism (5) is deactivated. When the trolley is not held on the sensor arm (9) during shopping, the brake mechanism (5) is activated and prevents the wheels from moving.

In a preferred embodiment of the invention, in the event that the product left on the shopping trolley is not detected and its image cannot be taken, the barcodes of the products are scanned by means of the reader (6) and included in the system.

Contactless payment can be made after the shopping is completed via the payment unit (7).

The control unit (8) receives the images of the products from the camera (2), performs product recognition and matching processes in the data centre and displays the information about the products to the customer on the screen. Information about the products mentioned may be price information, product content information.

The customer who starts shopping starts shopping by logging in via the control unit (8). In order to move the smart shopping trolley, the customer disables the brake mechanism (5) by holding the sensing arm (9) and enables the trolley to move. When a product is to be placed in the shopping basket, the brake mechanism (5) is activated by releasing the sensing arm (9) and the vehicle stops.

When a product is placed into the basket during shopping with the shopping trolley with smart system, the sensors (3) detect that a product has entered the basket. The signals generated as a result of the detection enable the lighting unit (1) to be activated. LED lights are illuminated in the lighting unit (1) to ensure that the camera (2) performs the image detection process in the best way. The camera (2) captures and saves the image. The weight detection unit (4) inside the product basket detects the product weight. The captured product image and the detected weight are sent to the data centre of the control unit (8). Product recognition and matching is performed in the data centre. The detected product description and price are displayed to the customer via the display on the control unit (8). If the product recognition is correct, the lighting unit (1) lights green to confirm the operation. If the product recognition is not approved, the lighting unit (1) lights red and the process is requested to be repeated or the product is added to the shopping list by scanning the barcode with the barcode reader (6). This cycle is repeated for each product purchase.

When the customer decides not to buy a product, the weight detection unit (4) perceives that the weight in the product basket decreases. The product removal status is detected by the weight detection unit (4) and sensors (3). The signals generated as a result of the detection enable the lighting unit (1) to be activated. LED lights are illuminated in the lighting unit (1) to ensure that the camera (2) performs the image detection process in the best way. The camera (2) captures and saves the image. The camera (2) detects which product is removed and the weight of the removed product is determined by the weight detection unit (4). The product detection process is carried out as specified in the product purchase phase.

The customer completes the shopping by making the payment through the control unit (8) or contactlessly at the card payment unit (7). Information about the payment made and the products purchased are displayed to the customers via the mobile device application.

In a preferred embodiment of the invention, payment may be made by means of a POS device placed in the product basket.

1. A shopping trolley with smart system, characterized by comprising:
a code located on the shopping trolley and defined specifically for each shopping trolley in the data centre, which enables the shopping trolley to be activated after being read by the application installed on the customer's mobile device;
a sensor that detects products being placed in or removed from the shopping basket;
a weight detection unit that detects the weight change when products are placed in or removed from the basket;
a camera that receives and transmits images of the product in order to identify the product left in the basket; and
a control unit that receives images from the camera performs product recognition and matching processes in the data centre, and displays the information about the products to the customer via the screen thereon.

2. The shopping trolley according to claim 1, further comprising a reader that reads the barcode of the product to identify the product.

3. The shopping trolley according to claim 1, further comprising a brake mechanism that stops the trolley wheels.

4. The shopping trolley according to claim 3, further comprising a sensing arm which is activated when held by the customer and deactivates the brake mechanism.

5. The shopping trolley according to claim 1, further comprising a lighting unit emitting light in different colours to inform the customer by receiving data on the product recognition process by the control unit.

6. The shopping trolley according to claim 1, wherein the control unit that ensures that the payment of the products received is made.

7. The shopping trolley according to claim 1, further comprising a payment unit for contactless payment.
